(19) United States
(12) Patent Application Publication
(10) Pub. No.: US 2013/0160267 A1
(43) Pub. Date: Jun. 27, 2013

(54) METHOD AND DEVICE FOR TAKING A SAMPLE IN A STEAM GENERATOR

(71) Applicant: AREVA NP GMBH, ERLANGEN (DE)

(72) Inventor: ERICH SEEBERGER, GROSSENSEEBACH (DE)

(73) Assignee: AREVA NP GMBH, ERLANGEN (DE)

(21) Appl. No.: 13/770,060

(22) Filed: Feb. 19, 2013

Related U.S. Application Data
(63) Continuation of application No. PCT/EP2011/061329, filed on Jul. 5, 2011.

(30) Foreign Application Priority Data
Aug. 17, 2010 (DE) 102010039413.0

(51) Int. Cl. G01N 1/08

(52) U.S. Cl. CPC G01N 1/08
USPC 29/426.3; 29/700

(57) ABSTRACT

A method takes a sample of a deposit on a secondary side of a pipe base plate of a steam generator of a nuclear power plant, In the method a steam generator pipe is removed from the pipe base plate to expose a hot pipe bore penetrating the pipe base plate. A removal tool of a device for taking the sample is introduced into the hot pipe bore by the primary side of the pipe base plate which is opposite the secondary side. A part of the deposit is removed by the removal tool as the sample. The sample is transported and removed from the steam generator. The removal tool is removed from the steam generator. The device contains the removal tool which can be introduced by a primary side of the pipe base plate in an exposed hot pipe bore penetrating the pipe base plate for removing the sample.

### CROSS-REFERENCE TO RELATED APPLICATION

This is a continuation application, under 35 U.S.C. §120, of copending international application No. PCT/EP2011/061329, filed Jul. 5, 2011, which designated the United States; this application also claims the priority, under 35 U.S.C. §119, of German patent application DE 10 2010 039 413.0, filed Aug. 17, 2010; the prior applications are herewith incorporated by reference in their entireties.

### BACKGROUND OF THE INVENTION

### Field of the Invention

The invention relates to a method and a device for taking a sample from a steam generator. The steam generator is part of a nuclear power plant. The sample is taken from a deposit on a secondary side of a pipe base plate of the steam generator.

A steam generator as part of a nuclear power plant has a primary circuit and a secondary circuit. The primary circuit conducts cooling-water leads to the nuclear reactor. The secondary side leads to a steam turbine. In the steam generator, the thermal energy of the cooling water of the primary circuit is transferred into the secondary circuit by the water being supplied to the secondary side being converted into steam. The steam generator is an approximately cylindrical, vertically standing vessel which is divided into a top part and a bottom part by a horizontally extending pipe base plate. The bottom part is the primary region and is associated with the primary circuit and the top part is the secondary region and is associated with the secondary circuit. The secondary region has a plurality of U-shaped steam generator pipes, the interior of which communicates with the primary region. To this end, the steam generator pipes penetrate the pipe base plate in a sealing manner. The end face inlet and outlet openings of the steam generator pipes are situated exclusively on the bottom side, that is to say the primary side of the pipe base plate. The top side, that is to say the secondary side of the pipe base plate is consequently provided with a plurality of steam generator pipes with a diameter of approximately 20 mm spaced only a few millimeters apart and is associated with the secondary side of the steam generator.

During the operation of the nuclear power plant, deposits from the secondary-side steam circuit are formed on the top side of the pipe base plate. The secondary side is therefore the deposit-bearing top side of the pipe base plate on the secondary side, on which the deposits are deposited in the direction of gravity. Different cleaning methods are known for removing the mud-like deposits. The methods are carried out when the nuclear power plant is shutdown for inspection. For example, in the case of the known pipe bank cleaning process, a movable lance is introduced in the steam generator through a secondary-side hand hole, the lance being introduced into the so-called pipe banks between the steam generator pipes. The deposits are flushed out using liquid which emerges under high pressure at the other front end.

Along with mud-like deposits, however, it is also possible for hard or encrusted deposits which are as hard as glass to be formed on the secondary side. It is not possible to remove the deposits using the above-mentioned, known secondary-side spray cleaning methods. In order to find suitable cleaning agents, the precise type, character, composition etc. of the deposits have to be determined. To this end, it is necessary to take a sample of the deposits in order to analyze them in a laboratory. Part of the deposits, therefore, has to be removed in the form of a sample. A tool is necessary for this purpose. As the deposits only occur in one region in the interior of the bundle of pipes, it is not practical to take a sample with a tool through the manhole on the secondary side on account of the tight amount of space available. As a result of the hardness of the deposits, a sample of this type is also designated as a scratch sample.

### SUMMARY OF THE INVENTION

It is accordingly an object of the invention to provide an improved method and a device for taking a sample in a steam generator which overcome the above-mentioned disadvantages of the prior art methods and devices of this general type.

The method is carried out when the nuclear power plant has been shutdown for an inspection. First of all, at least one steam generator pipe is removed from the pipe base plate in order to expose a hot pipe bore which penetrates the pipe base plate. The corresponding removal of a steam generator pipe is known as so-called “drawing” and represents a conventional method. As a rule, in this connection, part of a portion of a certain steam generator pipe connecting to the pipe base plate is cut off and removed. Once the steam generator pipe has been removed, there therefore remains a hot pipe bore which closes off in a flush manner with the top and bottom side, that is to say the secondary and primary side of the pipe base plate.

The sealing and mechanical stabilizing of the remainder of the drawn steam generator pipe associated with the known “drawing process” does not take place until the method has been completed. The created connection between the primary side and the secondary side is closed again in this manner. The method is therefore carried out beforehand when the hot pipe bore is still freely accessible at the drawing position of the pipe base plate and makes a passage between the primary side and the secondary side of the pipe base plate possible.

According to an embodiment of the invention, a removal tool of a device for taking the sample is introduced into the hot pipe bore from the primary side of the pipe base plate, which is located opposite the secondary side which has the deposits. Part of the deposits is then mechanically removed by way of the removal tool. The removed deposits form the sample. The sample is conveyed through the hot pipe bore to the primary side and is removed out of the steam generator. The removal tool is then also removed out of the steam generator.

The removal tool is therefore part of the device according to the invention which is explained in more detail below. The removal tool and where applicable further parts of the device are introduced into the steam generator through the manhole of the steam generator, which is located on the primary side and therefore below the base plate.

The device is introduced no the steam generator in a remotely controlled manner using an existing dome test manipulator or by way of personnel. Otherwise, the control thereof, in particular that of the removal tool is effected by remote control. At the end of the method, the remaining part of the device is naturally also removed out of the steam generator with the removal tool.

As claimed in the invention, the taking of the sample on the secondary side is affected from the primary side through the pipe base plate or an exposed hot pipe bore. In the case of known nuclear power plants, the hot pipe bore has a diameter, for example, of 19 mm. The pipe base itself has a thickness of approximately 640 mm between the primary side and the secondary side or the top side and the bottom side.

Obviously, it is possible, for example, once the steam generator pipe has been drawn and prior to introducing the removal tool, for a visual inspection of the top side to be effected, for example by a known endoscope which can be introduced through the hot pipe bore from the primary side. In this way, for example, the secondary side can be inspected in order to determine the thickness and the form of the deposits and in order to select a suitable removal tool. As a rule, a range of the most varied of removal tools that can be used are available for selection in the device.

As there is now access through the hot pipe bore, the conveying of the sample through the hot pipe bore to the primary side is effected in a simple manner.

The method or the device is defined below also by characteristics which refer to the center longitudinal axis of the hot pipe bore, This is only to be understood for the purposes of clarity: The device itself has the characteristics independently of the hot pipe bore also with reference to a center axis inherent to the device. In the same way, the explanations with reference to the center longitudinal axis, however, explain the functionality when using the device in a simplified and consequently intelligible manner, They refer to an assembled state of the removal tool. A so-called assembled state of the tool or of the device is provided when the latter is introduced into the hot pipe bore for carrying out the actual removal operation, the carrier, for example, is therefore fixed.

The device can have a carrier which carries the removal tool. The carrier together with the removal tool then forms a manipulator arm. In a preferred embodiment of the method, the carrier and the removal tool or the manipulator arm with the removal tool are introduced in advance into the hot pipe bore from the primary side, e.g. until the tool protrudes out of the bore on the secondary side in the region of the deposits. The carrier is then fixed in the hot pipe bore. With the carrier fixed, the removal tool is then moved in relation to the carrier in order to remove the sample from the deposit. The fixing of the carrier in the hot pipe bore is effected here, as a rule, with reference to a center longitudinal axis of the hot pipe bore in the axial, radial and circumferential direction. The advantage here is that a defined operating point or a defined securement for the removal tool is created by the fixed carrier. Proceeding from the position, the tool can be moved in a controlled and targeted manner in relation to the fixed carrier and consequently to the pipe base plate and the deposits in order to remove the sample.

In an advantageous embodiment, the removal tool—in the assembled state—is rotated about a drive axis which extends parallel to the center longitudinal axis of the hot pipe bore in order to remove the sample. A sample can be taken in a particularly good manner by a rotating tool. The removal tool is then, for example, a rotating milling or grinding head. The rotation parallel to the center longitudinal axis of the hot pipe bore is particularly simple to carry out because, for example, for this purpose it is possible to use a drive shaft, which carries the removal tool in a rigid manner and rotates about a drive axis parallel to the center longitudinal axis of the hot pipe bore.

In a preferred development of the method, with reference to the center longitudinal axis, the drive axis is adjusted in the radial direction and is advanced in the circumferential direction in order to remove the sample. in this way, it is possible for the circumferentially circular removal tool to be introduced initially through the bore concentrically with respect to the center longitudinal axis. When it then projects beyond the bore, it can be moved eccentrically and consequently can project beyond the edge of the bore such that it is able to engage the deposits.

Therefore in other words, for example, the above-mentioned rotating miffing or grinding head as the removal tool, proceeding from a position in which the drive axis coincides with the center longitudinal axis of the bore, is advanced, that is to say adjusted, in the radial direction from the center longitudinal axis onto the deposit until a desired depth of penetration into the deposit is achieved and the removal operation begins. The tool is then advanced in the circumferential direction in a circular manner by the drive axis circling the center longitudinal axis at a constant radius. After one complete revolution, a ring-shaped region of the deposit is taken as a sample and the removal tool can, for example, be adjusted a little further in the radial direction into the deposit. The tool is then advanced again by 360° in the circumferential direction, the drive axis circling the center longitudinal axis again at a greater radius. Both adjustment and advance can be selected in this connection as stepless parameters in order to adapt the removal operation in an optimal manner to the deposits. An adjustment can additionally be made in the axial direction of the center longitudinal axis of the bore in order to remove deposits which are greater in height than the height of the removal tool.

The device can also have a collecting container for the sample. As a rule, the collecting container is arranged such that in the assembled state it is located in the vicinity of the deposit to be removed. In a preferred embodiment, once the deposit has been removed, the sample is accommodated in a collecting container of the device and is then conveyed together with the collecting container to the primary side. The collecting container is, for example, emptied on the primary side or is removed entirely out of the steam generator together with the components of the device.

The device, therefore, has a removal tool which serves for removing part of the deposits in a mechanical manner as a sample. The removal tool can be introduced from the primary side of the pipe base plate into an exposed hot pipe bore of the pipe base plate, or can be guided through as far as up to the secondary side thereof or to the deposit at that location.

In a preferred embodiment, the device has a carrier which can be fixed in the hot pipe bore. The removal tool is then able to be moved in relation to the carrier. The carrier and the removal tool form a manipulator arm.

In a preferred embodiment, the device has a damping element which is arranged on the outer periphery of the carrier and can be supported against the inside wall of the hot pipe bore. In the assembled state, the damping element supports the carrier on the inside wall of the hot pipe bore. It therefore damps the carrier in the hot pipe bore in the radial, axial and circumferential direction with reference to the center longitudinal axis of the bore. In a preferred embodiment, the damping element is an element which can be pressure-filled with a medium, in particular a sleeve which surrounds the carrier in a ring-shaped manner and can be filled with compressed air. On the inner side thereof facing toward the carrier, the sleeve can then have, for example, a sliding bearing such that the sleeve bears fixedly against the inner wall of the hot pipe bore by way of the outer periphery thereof, the carrier however slides on the inner periphery thereof, i.e. can be rotated about the center longitudinal axis of the hot pipe bore. For easier removal of the carrier out of the hot pipe bore, the medium can be actively sucked out of the sleeve in order to compress same. Fixing occurs, for example, by a rubber sleeve which can be filled with compressed air at a pressure of 10 mbar.

In a further preferred embodiment, in the assembled state when the removal tool is therefore guided through the hot pipe bore and lies on the secondary side of the pipe base plate, the removal tool can be rotated about a drive axis which extends parallel to the center longitudinal axis of the hot pipe bore in order to remove the sample from the deposit. In a further preferred embodiment, in the assembled state the drive axis is adjustable with reference to the center longitudinal axis in the radial direction and can be advanced in the circumferential direction, that is to say therefore circling about the center longitudinal axis in a circular manner, in order to remove the sample. In addition, the removal tool can also be adjusted axially with reference to the center longitudinal axis. In a preferred embodiment, the carrier has a drive shaft. The removal tool is fixedly connected to the drive shaft and the drive shaft can be rotated about a drive axis, the drive axis extending parallel to the center longitudinal axis. The drive axis can be adjusted and advanced in the radial and circumferential direction with reference to the center longitudinal axis.

The carrier can also be realized in multiple parts. In a preferred development of the embodiment, the carrier additionally has a feed shaft which can be rotated about the center longitudinal axis in the assembled state. The feed shaft includes a cylinder bore which is eccentric with reference to the center longitudinal axis and extends parallel to the center longitudinal axis, in which cylinder bore is mounted a cylindrical adjustment shaft which, in turn, is mounted in the feed shaft so as to be rotatable about an adjustment axis. The drive axis, in turn, is mounted in an eccentric manner in the adjustment shaft. The drive shaft can also be referred to as the milling shaft and the adjustment shaft can be referred to as the eccentric shaft.

The feed shaft, adjustment shaft and drive shaft are each rotatable independently of one another about their respective rotational axes, namely the center longitudinal axis, the adjustment axis and the drive axis. To this end, for example, each shaft has associated therewith its own drive which is controllable independently of the other drives. The drives are located, for example, in a drive unit underneath the pipe base which is fastened, in turn, for example, on an adapter plate. The adapter plate is held on the bottom side or primary side of the pipe base, for example, in an adjacent hot pipe position, that is to say in a position other than the position of the hot pipe to be penetrated. The drives have a remote control capability, that is to say they are operated by remote control.

In a preferred embodiment, the device includes a collecting container for the accommodation of the sample. In other words, the sample is brought into the device itself and can be removed out of the steam generator with the device at the end of the removal operation without any additional expenditure and from there can be forwarded or processed further.

The collecting container is located in a favorable manner on the carrier or manipulator arm in the vicinity of the removal tool. The collecting container is realized in particular on the carrier as an end-face indentation. As the hot pipe bore extends vertically and the carrier points upward by way of its end face, the sample removed by the removal tool is collected in the end-face indentation of the carrier purely by gravity. When the manipulator arm is drawn back out of the hot pipe bore, in this way the sample is taken with it.

As the entire device is to be guided, for example, through a hot pipe bore of 19 mm in diameter, sliding bearings are used principally in the device in order to avoid, for example, bulky ball bearings. In this way, for example, the drive shaft, the adjustment shaft and the feed shaft are in each case mounted fitting into each other in a cylindrical manner by sliding bearings.

The removal tools, as a rule, are arbitrarily exchangeable, for example in the form of different milling and grinding heads or blades. The adjustment parameters of the removal tool with reference to the deposits are to be adapted to the tools and the type of the deposit in a corresponding manner, for example with reference to the speed of the removal tool, the adjustment e.g. within the range of between 0.1-3 mm or the feed speed, i.e. angular speed at which the drive axis circles the center longitudinal axis.

Other features which are considered as characteristic for the invention are set forth in the appended claims.

Although the invention is illustrated and described herein as embodied in a method and a device for taking a sample in a steam generator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view of a part of a steam generator;

FIG. 2 is a sectional view of the steam generator from FIG. 1 with a device according to the invention;

FIG. 3 is a detailed sectional view of a manipulator arm of the device;

FIG. 4 is a top view of the manipulator arm from FIG. 3 in a direction of arrow IV;

FIG. 5 is a sectional view of an upper end of the manipulator arm with a sleeve;

FIG. 6 is an illustration of a removal tool; and

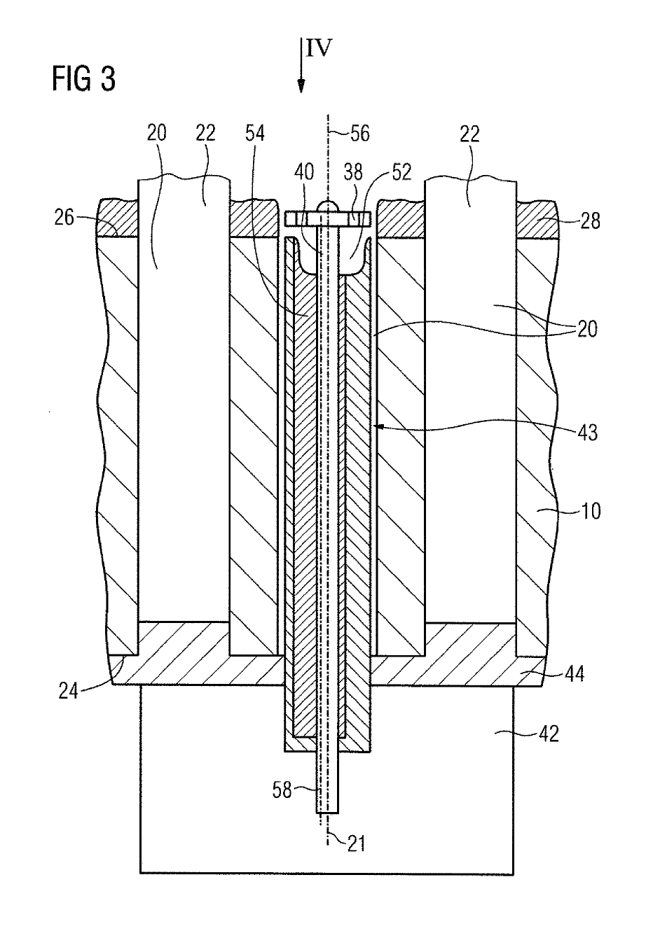

Fig, 7 is a top view of a secondary side of the pipe base from FIG. 3 in the direction of the arrow IV.

### DETAILED DESCRIPTION OF THE INVENTION

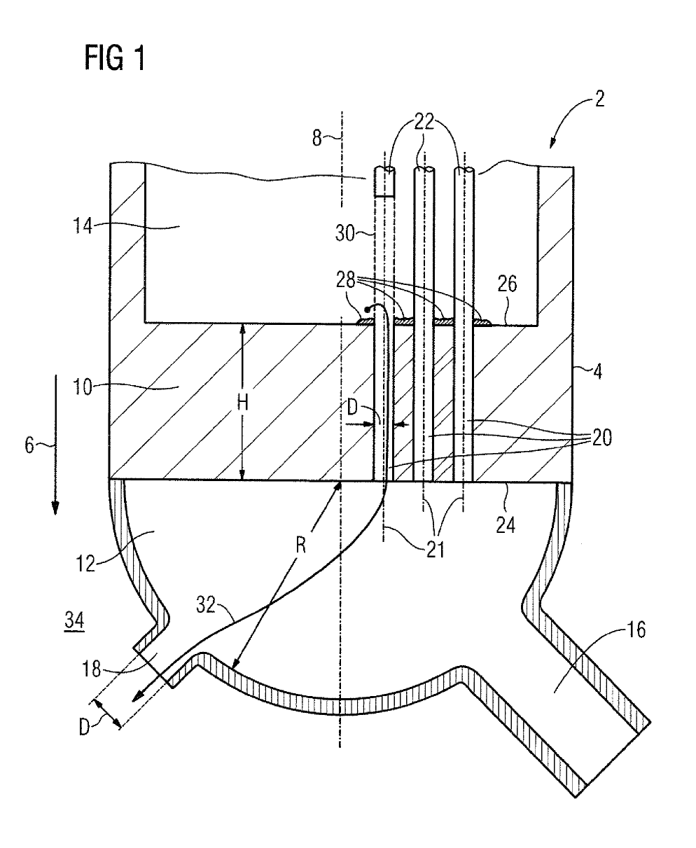

Referring now to the figures of the drawing in detail and first, particularly, to FIG. 1 thereof, there is shown a cutout from a nuclear power plant 2, a section of part of a vertical steam generator 4, namely the bottom part thereof. The direction of gravity 6 therefore extends parallel to a center longitudinal axis 8 of the steam generator 4. The steam generator 4 includes a pipe base plate 10 which extends transversely hereto and accordingly horizontally and has a height H of approximately 700 mm. The pipe base plate 10 separates a primary region 12 of the steam generator 4 located at the bottom from the secondary region 14 thereof. The primary region is connected by a connecting piece 16 to a non-illustrated reactor pressure container of the nuclear power plant 2 and in operation conducts cooling water on the primary side. The inspection shutdown of the nuclear power plant 2 is shown, which is why the cooling water has been removed, The primary region 12 forms a steam generator dome which is accessible through a manhole 18, i.e. is able to be passed through by non-illustrated service personnel.

The pipe base plate 10 has continuous hot pipe bores 20 with center longitudinal axes 21. In the secondary region 14, a U-shaped steam generator pipe 22, which penetrates the secondary region 14, connects to two of the hot pipe bores 20 each. During the operation of the nuclear power plant 2, primary-side cooling water traverses the primary region 12, the hot pipe bores 20 and the steam generator pipes 22. In the secondary region 14, as a result, secondary-side cooling water—which has also been removed during the inspection shutdown—is evaporated and forwarded to a non-illustrated steam turbine.

The pipe base plate 10 has, as a bottom flat side or under surface, a primary side 24 which faces the primary region 12 and an opposite secondary side 26 which faces the secondary region 14. As, with the upright steam generator 4, the secondary side 26 provides the bottom-side base of the secondary region 14, deposits 28 are deposited there during the operation of the nuclear power plant. Unlike soft deposits which are able to be removed by a known pipe bank cleaning method, the deposits 28 are hard deposits which can be as hard as glass and cannot be removed using the known mechanical, as a rule spray cleaning methods. A sample is then to be taken from the deposits 28 using the method as claimed in the invention.

As claimed in the invention, the sample is taken from the primary region 12 via a hot pipe bore 20 which penetrates the pipe base plate 10. As the primary and secondary circuit and consequently also the primary region 12 and the secondary region 14 are hermetically sealed off from each other, an access first of all has to be created. For this purpose, using a known method that is not explained in any more detail, one of the hot pipes 22 has to be partially removed, called “drawing” in professional jargon. A section 30 of the steam generator pipe 22, shown in FIG. 1 by the dotted line and connecting to the pipe base plate 10, is cut off in this connection both from the pipe base plate 10 and from the remaining steam generator pipe 22 and is removed through the hot pipe bore 20. The hot pipe bore 20 consequently connects in a flush manner to the primary side 24 and the secondary side 26, which is to say to the two flat sides of the pipe base plate 10. The hot pipe bore 20 now has an inside diameter D of 19 mm. The dome-shaped primary region 12 now has an inside radius R of approximately 1600 mm. A relatively high dose equivalent prevails there. The manhole 18 has a diameter D of approximately 400-420 mm. The drawing of the steam generator pipe 22, consequently, creates an access, which is indicated by an arrow 32, from the exterior 34 of the steam generator 4 to the deposit 28. The sample is to be taken from the deposit 28 along this path.

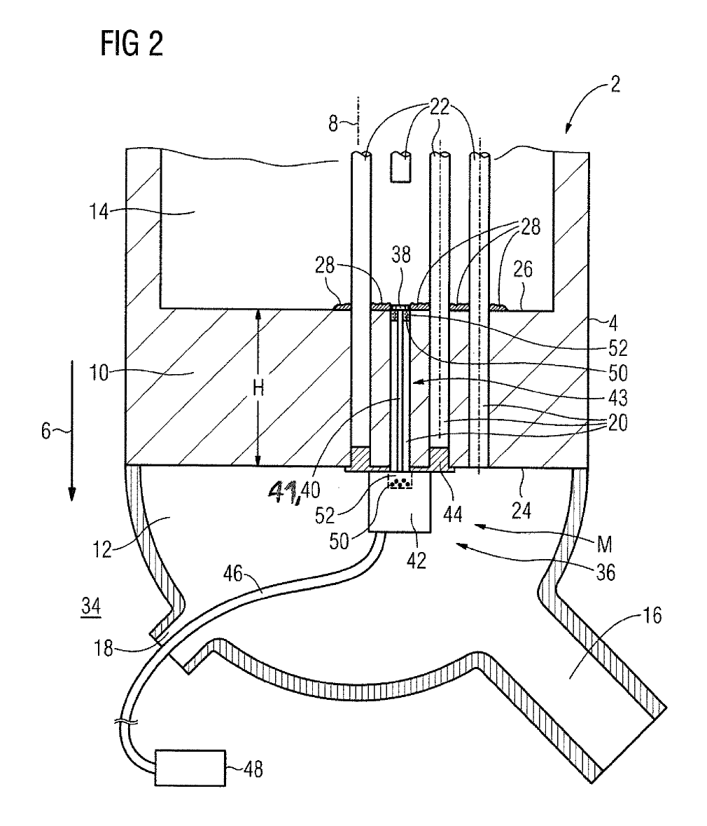

FIG. 2 shows a device 36 according to the invention and at least part of the device 36 is introduced into the steam generator 4 through the manhole 18. The device 36 essentially has a removal tool 38 which can be guided through into the hot pipe bore 20 or through same as far as up to the secondary side 26. The removal tool 38 is fixedly mounted on a carrier 41 in the form of a drive shaft 40. The carrier 41 and the removal tool 38 therefore together form a manipulator arm 43. FIG. 2 shows the assembled state M of the device 36, when namely the removal tool 38 or the manipulator arm 43 is moved into the region of the deposit 28.

The drive shaft 40 is driven by a drive unit 42. As the removal tool 38 is mounted in a rigid manner on the drive shaft 40, the removal tool 38 is driven in this manner. The drive unit 42, in turn, is fastened on an adapter plate 44. The adapter plate 44 is fastened on the pipe base plate 10. This occurs, for example, by engagement in the hot pipe bores 20 adjacent to the active hot pipe bore 20, into which, for example, retaining pins are introduced in a clamping manner.

The drive unit 42 is connected by a control cable 46 to a control unit 48 which is arranged in the exterior 34 and which enables the control of all of the operations of the device 36 by remote control.

During the operation of the device 36, the drive unit 42 is actuated by the control unit 48 in order to control, in turn, the removal tool 38. The removal tool is moved to the deposits 28 or adjusted in order to remove part thereof in a mechanical manner. For this purpose, the drive unit 42 includes the most varied drives, gearing units and transmitters in order to control the removal tool 38—for example a milling cutter. For example, the rotation thereof and also the movement of the manipulator arm 43 is effected in the form of adjustment and feed movements.

The removed parts of the deposit 28 pass as a sample 50 into a collecting container 52 of the device 36, which is provided, for example, in the vicinity of the removal tool 38 on the drive shaft 40 or as an alternative to this, in the region of the drive unit 42.

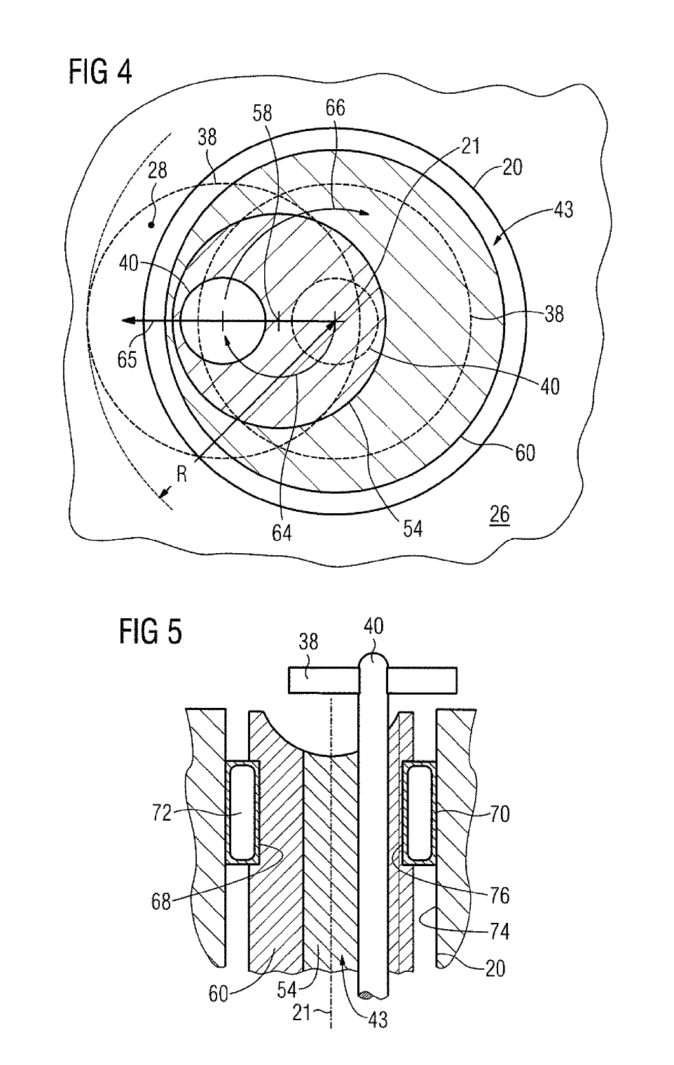

FIG. 3 shows part of the device 38, especially the manipulator arm 43, in detail. FIG. 3 shows the assembled state M again and FIG. 4 shows a top view of the manipulator arm 43 in the direction of the arrow IV. FIGS. 3 and 4 show an alternative embodiment where the drive shaft 40 is mounted in an eccentric manner in an adjustment shaft 54. A drive axis 56, that is to say the center longitudinal and rotational axis of the drive shaft 40, does not coincide with the center longitudinal axis of the adjustment shaft 54, namely the adjustment axis 58. The adjustment shaft 54, in turn, is mounted in an eccentric manner in a feed shaft 60, which, in turn, is rotatable about the center longitudinal axis thereof. In the assembled state M, the manipulator arm 43 or the feed shaft 60 is mounted in the hot pipe bore 20 in such a manner that the center longitudinal axis of the feed shaft coincides with the center longitudinal axis 21.

FIG. 3 and the position in Fig, 4 shown by the dotted line show the adjustment shaft 54 in a rotational position in which the drive shaft 40 is pivoted into the center of the manipulator arm 43 and consequently into the center of the feed shaft 60. The drive axis 56 consequently also coincides with the center longitudinal axis 21. The removal tool 38, the drive shaft 40, the adjustment shaft 54 and the feed shaft 60 therefore here together form the manipulator arm 43 which can be introduced into the hot pipe bore 20. The position of the adjustment shaft 54 forms an entry and exit position for the manipulator arm 62 with reference to hot pipe bore 20, as the removal tool 38 can be guided centrally through the hot pipe bores 20 and does not project beyond the cross section of the remaining manipulator arm 43, in particular of the feed shaft 60.

By the dotted line, FIG. 4 shows the hot pipe bore 20 with a manipulator arm 62 inserted therein and the removal tool 38 in the position according to FIG. 3. The associated position of the drive shaft 40 is shown by the dotted line. Compared to FIG. 3, however, in FIG. 4 the adjustment shaft 54 is pivoted by 180° about the adjustment axis 58 in the direction of the arrow 64. Therefore effectively the removal tool 38 is adjusted into the radial direction 65 which is symbolized by an arrow. As the adjustment shaft 54 is mounted in an eccentric manner in the feed shaft 60, the drive shaft 40 is consequently moved together with the removal tool 38 radially outward with reference to the center longitudinal axis 21. In this way, the removal tool 38 moves into contact with the deposits 28 surrounding the hot pipe bore 20 on the secondary side 26. FIG. 4 shows the maximum adjustment position for the removal tool 38 which can consequently move into engagement with the deposits 28 in a region with a diameter of 25 mm (radius R=12.5 mm) about the center longitudinal axis 21. A sample 50 can be removed in the region. Where there is a minimum distance of 3.6 mm between two steam generator pipes 22 with a diameter of 19 mm, there is consequently a safety distance of 0.6 mm between the removal region with a diameter of 25 mm and the adjacent steam generator pipe 22.

The entire above-mentioned region can consequently be removed as a feed of the drive shaft 40 and consequently of the removal tool 38 is affected in the direction of the circumferential direction 66, which is symbolized by an arrow, by rotating the feed shaft 60 about the center longitudinal axis 21. By a rotation of the adjustment shaft 54 by less than 180° about the adjustment axis 58, even smaller adjustments can be effected in the radial direction with reference to the center longitudinal axis 21.

In FIG. 3, the manipulator arm 43 is held solely by the adapter plate 44 or the drive unit 42. FIG. 5 shows a further exemplary embodiment of the invention, namely an improved adjusting or mounting arrangement of the manipulator arm 43 in the hot pipe bore 20. For this purpose, the manipulator arm 62 or the feed shaft 60 has a radially inwardly directed groove 68 on the outer periphery thereof, in which a clamping element 70 in the form of a hollow sleeve is inserted. The interior 72 thereof can be filled with a medium, for example compressed air. In the inflated state, the clamping element 70 then supports the manipulator arm 62 on the inner wall 74 of the hot pipe bore 20 and centers same. A rotation of the manipulator arm 43 about the center longitudinal axis 21 is nevertheless possible, as between the manipulator arm and the damping element 70 is formed a sliding bearing 76, along which the feed shaft 60 slides in the clamping element 70 which is fixed in the hot pipe bore 20. FIG. 5 also shows the eccentric position of the drive shaft 40 from FIG. 4 once again such that the removal tool 38 projects radially outward beyond the hot pipe bore 20. The clamping element 70 can also be actively emptied in order to compress the hot pipe bore and in order to enable problem-free removal of the clamping element 70 together with the manipulator arm 43 out of the hot pipe bore 20 in this manner.

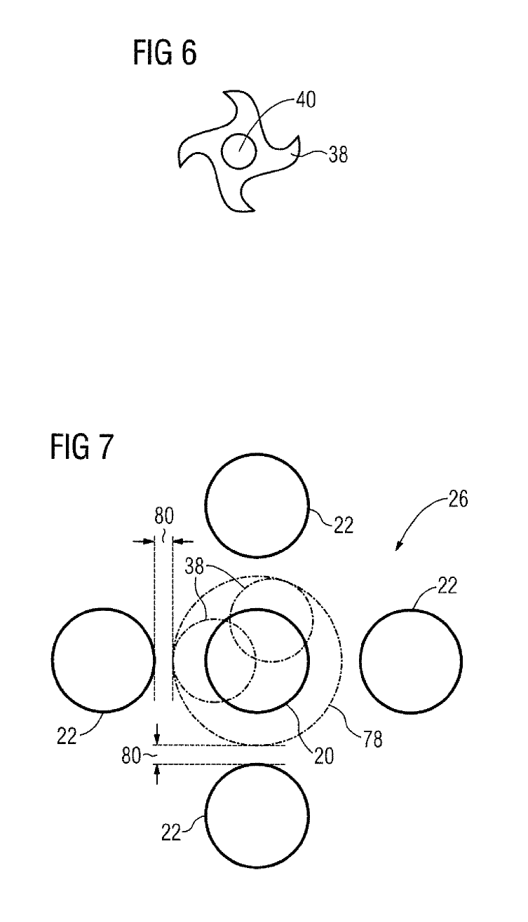

As an example, FIG. 6 shows a top view in the direction of the arrow IV onto a removal tool 38 in the form of a milling cutter which is placed onto a drive shaft 40.

FIG. 7 shows a top view onto the secondary side 26, that is to say in the direction of the arrow IV in FIG. 3, showing a central hot pipe bore 20 and adjacent steam generator pipes 22 surrounding the hot pipe bore. The original steam generator pipe 22 has therefore already been drawn from the central hot pipe bore 20. A dotted line additionally shows a circumscribed circle 78 which illustrates that region which can be reached by a removal tool 38 that has been adjusted to the maximum. The circumscribed circle 78 is dimensioned such that a safety distance 80 to the adjacent steam generator pipes 22 is always maintained in order not to damage the steam generator pipes unintentionally by the re oval tool 38 when taking a sample.

1. A method for taking a sample of a deposit on a secondary side of a pipe base plate of a steam generator of a nuclear power plant, which comprises the steps of:
removing a steam generator pipe from the pipe base plate for exposing a hot pipe bore which penetrates the pipe base plate;
introducing a removal tool of a device for taking the sample into the hot pipe bore from a primary side of the pipe base plate being disposed opposite the secondary side;
mechanically removing part of the deposit by way of the removal tool as the sample;
in an assembled state, rotating the removal tool about a drive axis extending parallel to a center longitudinal axis of the hot pipe bore for removing the sample;
adjusting the drive axis with reference to the center longitudinal axis in a radial direction and is advanced in a circumferential direction for removing the sample;
conveying the sample through the hot pipe bore to the primary side and the sample is removed out of the steam generator; and
removing the removal tool out of the steam generator.

2. The method according to claim 1, which further comprises fixing a carrier of the device in the hot pipe bore, and moving the removal tool in relation to the carrier for removing the sample from the deposit.

3. The method according to claim 1, wherein, after removal, accommodating the sample in a collecting container of the device and the sample is conveyed together with the collecting container to the primary side.

4. A device for taking a sample of a deposit on a secondary side of a pipe base plate of a steam generator of a nuclear power plant, the device comprising:
a removal tool, for being introduced from a primary side of the pipe base plate, being disposed opposite the secondary side, into an exposed hot pipe bore, penetrating the pipe base plate, for removal of part of the deposit in a mechanical manner as the sample, wherein, in an assembled state, said removal tool is rotatable about a drive axis extending parallel to a center longitudinal axis of the hot pipe bore for removing the sample from the deposit, wherein, in the assembled state, the drive axis is adjustable with reference to the center longitudinal axis in a radial direction and can be advanced in a circumferential direction for removing the sample.

5. The device according to claim 4, further comprising a carrier which can be fixed in the hot pipe bore, and said removal tool can be moved in relation to said carrier.

6. The device according to claim 5, further comprising a damping element disposed at an outer periphery of said carrier and can be supported against an inner wall of the hot pipe bore.

7. The device according to claim 5, wherein said carrier includes a drive shaft which is fixedly connected to said removal tool and is rotatable about the drive axis parallel to the center longitudinal axis, wherein the drive axis is adjustable and advanceable in the radial direction and the circumferential direction with reference to the center longitudinal axis.

8. The device according to claim 7, further comprising an adjusting shaft, said carrier having a feed shaft being rotatable about the center longitudinal axis and in which is mounted in an eccentric manner, said adjusting shaft, which is rotatable about an adjusting axis which is parallel to the center longitudinal axis, and in which said drive shaft is mounted in an eccentric manner.

9. The device according to claim 8, further comprising a sliding bearing, said drive shaft mounted in said adjusting shaft and said adjusting shaft mounted in said feed shaft by means of said sliding bearing.

10. The device according to claim 4, further comprising a collecting container for accommodating the sample.
